(19) United States
(12) Patent Application Publication
(10) Pub. No.: US 2024/0346404 A1
(43) Pub. Date: Oct. 17, 2024

(54) TECHNIQUES FOR UTILIZING VIDEO GAMES TO IDENTIFY AND RECRUIT CANDIDATES FOR JOB POSITIONS

(71) Applicant: Smarter Reality, LLC, Round Rock, TX (US)

(72) Inventor: Walter Franklin Coppersmith, III, Round Rock, TX (US)

(21) Appl. No.: 18/604,462

(22) Filed: Mar. 13, 2024

Related U.S. Application Data
(60) Provisional application No. 63/496,325, filed on Apr. 14, 2023.

(51) Int. Cl. G06Q 10/0631; A63F 13/533; A63F 13/61; A63F 13/67; A63F 13/79; G06Q 10/1053

(52) U.S. Cl. CPC G06Q 10/063112; A63F 13/533; A63F 13/61; A63F 13/67; A63F 13/79; G06Q 10/1053

(57) ABSTRACT

Representative embodiments set forth herein provide a method for promoting available job positions to players of a video game. The method can include the steps of (1) accessing a recruitment profile of a player of the video game, wherein the recruitment profile is based at least in part on interactions of the player with the video game, (2) accessing a plurality of available job positions, (3) for each available job position of the plurality of available job positions: generating, based on (i) the recruitment profile, and (ii) respective information associated with the available job position, a respective predicted interest level the player would have in the available job position, (4) filtering the plurality of available job positions based on the predicted interest levels, and (5) causing content associated with at least one available job position of the plurality of available job positions to be presented to the player.

### CROSS-REFERENCE TO RELATED APPLICATIONS

The present application claims the benefit of U.S. Provisional Application No. 63/496,325, entitled “TECHNIQUES FOR UTILIZING VIDEO GAMES TO INDENTIFY AND RECRUIT CANDIDTATES FOR JOB POSITIONS,” filed Apr. 14, 2023, the content of which is incorporated by reference herein in its entirety for all purposes.

### FIELD OF INVENTION

The embodiments described herein set forth techniques for utilizing video games to identify and recruit candidates for real-world job positions. In particular, the techniques involve generating and maintaining job recruitment profiles for players of a video game and then utilizing such job recruitment profiles to effectively promote and potentially fill available job positions.

### BACKGROUND

Effective recruitment for job positions is an important aspect of any organization's growth and success. The process of attracting, sourcing, and selecting the right candidates for a given job position is both challenging and time-consuming. Presently, sourcing candidates for job positions can be done through various channels, including job portals, social media, employee referrals, campus recruitment drives, and so on. However, finding eligible candidates for job positions through the foregoing channels continues to be a challenging task. In particular, the current job market is highly competitive, and organizations are facing difficulties in finding the individuals to fill available job positions. This could be due to a shortage of skilled workers in certain industries, a mismatch between the job requirements and the candidate's skills, experience, and/or interests, and so on.

Accordingly, what is needed is an improved technique for effectively identifying eligible candidates for available job positions.

### SUMMARY

The embodiments described herein set forth techniques for utilizing video games to identify and recruit candidates for real-world job positions. In particular, the techniques involve generating and maintaining job recruitment profiles for players of a video game and then utilizing such job recruitment profiles to effectively promote and potentially fill available job positions.

One embodiment sets forth a method for promoting available job positions to players of a video game. According to some embodiments, the method can be implemented by a computing device, and includes the steps of (1) accessing a recruitment profile of a player of the video game, where the recruitment profile is based at least in part on interactions of the player with the video game, (2) accessing a plurality of available job positions, (3) for each available job position of the plurality of available job positions: generating, based on (i) the recruitment profile, and (ii) respective information associated with the available job position, a respective predicted interest level the player would have in the available job position, (4) filtering the plurality of available job positions to exclude available job positions with respective predicted interest levels that do not satisfy a threshold value, and (5) causing content associated with at least one available job position of the plurality of available job positions to be presented to the player via a user interface that is accessible to the player.

Another embodiment sets forth a method for managing recruitment profiles for players of a video game. According to some embodiments, the method can be implemented by a computing device, and includes the steps of (1) receiving, from a player, a request to access to the video game, where the request includes characteristic information associated with the player, (2) generating a recruitment profile based on the characteristic information, where the recruitment profile includes at least one digital playing card that correlates to at least one characteristic of the player, (3) modifying an instantiation of the video game based on the recruitment profile, and (4) permitting the player to access the instantiation of the video game.

Yet another embodiment sets forth a method for modifying a video game based on job position recruitment goals. According to some embodiments, the method can be implemented by a computing device, and includes the steps of (1) receiving information about at least one available job position in need of fulfillment, (2) identifying, based on the information, at least one digital playing card that, when utilized within the video game, increases a probability of interest in the at least one available job position, and (3) dynamically adjusting at least one property of the at least one digital playing card and/or the video game to increase a likelihood that players of the video game will be exposed to and acquire the at least one digital playing card.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an overview of different entities that can be configured to perform the various techniques described herein, according to some embodiments.

FIGS. 2A-2P illustrate conceptual diagrams of example user interfaces displayed to a player throughout their hypothetical engagement with a video game, according to some embodiments.

FIG. 3 illustrates a method for promoting available job positions to players of a video game, according to some embodiments.

FIG. 4 illustrates a method for managing recruitment profiles for players of a video game, according to some embodiments.

FIG. 5 illustrates a method for modifying a video game based on job position recruitment goals, according to some embodiments.

FIG. 6 illustrates a detailed view of a computing device that can be used to implement the various techniques described herein, according to some embodiments.

### NOTATION AND NOMENCLATURE

Various terms are used to refer to particular system components. Different entities may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments can be practiced without some or all of these specific details. In other instances, well-known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting such that other embodiments can be used, and changes can be made without departing from the spirit and scope of the described embodiments.

Representative embodiments set forth herein disclose techniques for utilizing video games to identify and recruit candidates for real-world job positions. In particular, the techniques involve generating and maintaining job recruitment profiles for players of a video game and then utilizing such job recruitment profiles to effectively promote and potentially fill available job positions.

A first embodiment sets forth a method for promoting available job positions to players of a video game. According to some embodiments, the method can be implemented by a computing device, and includes the step of (1) accessing a recruitment profile of a player of the video game, where the recruitment profile is based at least in part on interactions of the player with the video game. According to some embodiments, the interactions can include digital playing card collection and/or usage metrics associated with the player—where, as described in greater detail herein, each digital playing card corresponds/relates to a respective job position.

According to some embodiments, the recruitment profile can be based on other aspects, such as characteristic information associated with the player. The characteristic information can be obtained through a variety of approaches. For example, the characteristic information can be obtained through the player's engagement with a recruitment center affiliated with the video game, through prompts presented to the player when interacting with the video game, through publicly-available information about the player, and so on.

According to some embodiments, the first method can further include the step of (2) accessing a plurality of available job positions. This can include, for example, interfacing with at least one entity that manages information about available job positions, such as an employer, a recruitment agency, etc., and obtaining the information in a format that can be interpreted by the computing device (e.g., a standardized database format, a self-describing format (e.g., extensible markup language (XML) format), a proprietary format, etc.).

According to some embodiments, the first method can further include the step of (3) for each available job position of the plurality of available job positions: generating, based on (i) the recruitment profile, and (ii) respective information associated with the available job position, a respective predicted interest level the player would have in the available job position. The computing device can implement this step using a variety of approaches. Under one example approach, the computing device can (1) provide the recruitment profile to a first machine learning model to generate a first output, (2) provide the respective information associated with the available job position to a second machine learning model to generate a second output, and (3) generate the respective predicted interest level through analysis of the first and second outputs (e.g., using additional logic, machine learning models, etc.). To implement this approach, the different machine learning models can be trained with appropriate historical information that tunes the manner in which the machine-learning models generate their respective outputs. For example, the first machine learning model can be trained using recruitment profiles of other players and identified/relevant interests of those players. In the same vein, the second machine learning model can be trained using information associated with previously-available job positions (that have since been filled by the other players) and identified/relevant characteristics of those job positions. In this manner, the first and second outputs can be effectively analyzed (e.g., using an additional machine learning model, using other analytical approaches, etc.) to generate the respective predicted interest level.

Under another example approach, the computing device can provide the recruitment profile—along with the respective information for a given available job position—to machine-learning models to generate one or more outputs from which the respective predicted interest level for the given available job position can be derived. To implement this approach, the machine-learning models can be trained using historical information about matchups between recruitment profiles and job positions that resulted in successful conversions (i.e., job positions that ultimately were filled by individuals associated with the recruitment profiles).

It is noted that any type/number of machine learning models can be utilized, and that the outputs produced by such machine learning models can be aggregated in any fashion (e.g., weights, averages, etc.) without departing from the scope of this disclosure. It is further noted that the predicted interest levels can be implemented using any metrical approach (e.g., zero (0) to one-hundred (100), one (1) to ten (10), etc.) without departing from the scope of this disclosure.

According to some embodiments, the first method can further include the step of (4) filtering the plurality of available job positions to exclude available job positions with respective predicted interest levels that do not satisfy a threshold value. According to some embodiments, the threshold value can be set in accordance with the format, range, etc., of the respective interest levels that are generated so that they can be properly filtered using the threshold value. For example, if the interest levels range from zero (0) to one-hundred (100)—where one-hundred (100) represents a strongest interest level—then the threshold value can be set at ninety (90) when only the jobs having high predicted interest levels should remain intact for subsequent utilization. It is noted that the foregoing examples are not meant to be limiting, and that any metrical approach can be utilized to effectively filter the plurality of available job positions. For example, the respective interest levels can be adjusted based on additional analyses, computations, etc., prior to being compared against the threshold value, without departing from the scope of this disclosure.

According to some embodiments, the first method can further include the step of (5) causing content associated with at least one available job position of the plurality of available job positions to be presented to the player via a user interface that is accessible to the player. The content can include, for example, a job position title associated with the at least one available job position, a geographical location of the at least one available job position, compensation information associated with the at least one available job position, relocation package information associated with the at least one available job position, contact information of at least one entity and/or person with whom to interface, and the like. The content can further include links that enable the player to actively engage with automated/remote support staff, using any communications medium (e.g., text, phone, video, etc.).

Another embodiment sets forth a second method for managing recruitment profiles for players of a video game. According to some embodiments, the method can be implemented by a computing device, and includes the step of (1) receiving, from a player, a request to access to the video game. This can occur, for example, in conjunction with the player installing/loading the video game, with the player loading the video game in a web browser, and so on. It is noted that the video game can be implemented using any platform without departing from the scope of this disclosure. According to some embodiments, the request can include characteristic information associated with the player. The information can be obtained, for example, via at least one prompt presented to the player when engaging with a recruitment center affiliated with the video game, via at least one prompt presented to the player in conjunction with receiving the request to access the video game (e.g., during a registration process), via publicly-available information about the player, and the like. The characteristic information can include, for example, demographic information about the player, interests of the player, activities of the player, and so on. It is noted that the foregoing examples are not meant to be limiting, and that the characteristic information can include any conceivable information associated with the player without departing from the scope of this disclosure.

According to some embodiments, the second method can further include the step of (2) generating a recruitment profile based on the characteristic information, where the recruitment profile includes at least one digital playing card that correlates to at least one characteristic of the player (where, as described herein, each digital playing card corresponds/relates to a respective job position). According to some embodiments, this step can include (i) providing the characteristic information to at least one machine learning model to produce an output, (ii) matching the output to the at least one digital playing card, and (iii) including the at least one digital playing card in the recruitment profile. To implement this approach, the machine learning models can be trained with appropriate historical information that tunes the manner in which the machine-learning models generate their outputs. For example, a given machine learning model can be trained using recruitment profiles of other players and the digital playing cards collected/utilized by the other players. In this manner, the output(s) of the machine learning model(s) can represent (or be further-analyzed to determine) the digital playing cards that the player will most likely be interested in and utilize.

According to some embodiments, the second method can further include the step of (3) modifying an instantiation of the video game based on the recruitment profile. This can involve, for example, pre-loading the video game to include the digital playing cards included in the recruitment profile generated at step (2). This can also involve any other modifications that are appropriate, such as adjusting a welcome message presented when starting the video game, adjusting a starting point of the video game, adjusting operational mechanics of the video game, and so on. It is noted that the foregoing techniques are not meant to be limiting, and that any number/form of modifications to the video game can be made, based on the recruitment profile (or any other information/considerations), without departing from the scope of this disclosure.

According to some embodiments, the second method can include the step of (4) permitting the player to access the instantiation of the video game. This can involve, for example, causing the video game (adjusted in accordance with step (3) discussed above) to be presented to at least one player via a user interface, such as through a web browser in which the video game is implemented, a software application in which the video game is implemented, and the like.

According to some embodiments, the second method can include the additional step of (5) monitoring interactions of the player with the instantiation of the video game. The interactions can include, for example, digital playing card collection and/or usage metrics associated with the player, in-game activities pursued by the player, and so on. According to some embodiments, the second method can include the additional step of (6) modifying the recruitment profile, based on the interactions, to produce an updated recruitment profile, and (7) modifying the instantiation of the video game based on the updated recruitment profile. These steps can be beneficial in that the recruitment profile for the player is continuously maintained so that it accurately reflects the aggregate/current interests of the player—which, as described herein, can be utilized to identify promote available job positions in which the player may be interested.

According to some embodiments, the second method can include the additional steps of (8) receiving a second request to obtain a digital playing card not included in the recruitment profile, and (9) identifying, based on historical information associated with acquisitions of digital playing cards by the player and/or other players, a task type that is most likely to be completed to obtain the digital playing card. Any approach can be utilized to implement the foregoing steps, such as machine learning models that are trained to receive historical information as input and to output information representative of the task type. Task types can include, for example, filling out a questionnaire, watching a video, interacting with a simulation, answering a quiz, visiting a website, downloading an application, subscribing to informational communications, and so on. It is noted that the foregoing task types are exemplary and not meant to be limiting, and that any task type can be implemented without departing from the scope of this disclosure.

In any case, when the task type is identified, the method can include the additional steps of (10) generating, based on the digital playing card and the task type, a task for the player to complete, and (11) providing the task to the player. For example, if the digital playing card is associated with the real-world job of being a fighter jet repair technician—and the task type involves interacting with a simulation—then the task can involve completing a simulated and guided removal of a jet engine from a fighter jet. In another example, if the digital playing card is associated with the real-world job of being a munitions specialist—and the task type involves completing a quiz—then the task can involve quizzing the player about various considerations that must be taken when managing munitions.

It is noted that the foregoing examples are not meant to be limiting, and that any type of task can be generated based on the digital playing card and the task type without departing from the scope of this disclosure. It is additionally noted that the task can be generated based on other information, under analyses at any level of granularity, without departing from the scope of this disclosure. According to some embodiments, the other information can include characteristic information about the player that can be used to identify task types with which the player would be most likely to engage. For example, if the characteristic information reveals that the player is interested in gaming—which suggests that the player is more interested in interactive environments vs. informational environments—then an emphasis can be placed on utilizing simulation task types. In another example, if the characteristic information reveals that the player is interested in challenging their existing knowledge—which suggests that the player is more interested in quizzes than other activities—then an emphasis can be placed on utilizing quiz task types. Again, it is noted that the foregoing examples are not meant to be limiting, and that the tasks can be selected based on any information, analyzed at any level of granularity, without departing from the scope of this disclosure.

It is additionally noted that the tasks can be dynamically generated based on any information without departing from the scope of this disclosure. For example, the surrounding environment of a simulation-based task can be generated in accordance with the player's locale (e.g., as indicated by their characteristic information) to garner a deeper engagement by the player. In another example, an estimated attention span of the player (e.g., as indicated by their in-game activity) can be used to adjust the overall length of a given video so that the video appropriately aligns with the player's attention span. In yet another example, when the task involves downloading an application, the appropriate application can be dynamically identified based on the player's characteristic information. In particular, if the characteristic information indicates that the player is more interested in informational interactions, then the application can involve an “e-reader” that provides access to a training guide that corresponds to the digital playing card the player is seeking to obtain. Again, the foregoing examples are not meant to be limiting, and the tasks can be dynamically generated based on any information, analyzed at any level of granularity, without departing from the scope of this disclosure.

In any case, when the task is provided to the player, the second method can include the additional step of (12) monitoring an execution of the task by the player. According to some embodiments, the computing device can gather information about the execution of the task and use the information to improve the overall accuracy of the aforementioned machine learning models. The second method can include the additional step of (13) in response to determining that the player completes the task, associating the digital playing card with the recruitment profile. According to some embodiments, the task can be associated with properties having values that indicate whether the task has been completed. Ultimately, associating the digital playing card with the recruitment profile can enable the player to access the digital playing card when and where appropriate.

Yet another embodiment sets forth a third method for modifying a video game based on job position recruitment goals. According to some embodiments, the method can be implemented by a computing device, and includes the step of (1) receiving information about at least one available job position in need of fulfillment. Again, this step can involve interfacing with at least one entity that manages information about available job positions, such as a government or business entity seeking to fill the at least one available job position, and obtaining the information in a format that can be interpreted by the computing device.

According to some embodiments, the third method can include the step of (2) identifying, based on the information, at least one digital playing card that, when utilized within the video game, increases a probability of interest in the at least one available job position. As described herein, each digital playing card can correspond to a respective job position. For example, when the video game pertains to a military environment, the digital playing cards can be associated with repair technicians, munitions specialists, crew chiefs, medical specialists, and so on. In another example, when the video game pertains to a racing environment (e.g., cars), the digital playing cards can be associated with service technicians, pit crew technicians, operations managers, and so on. It is noted that the foregoing example environments are not meant to be limiting, and that the embodiments described herein can apply to any theme, environment, etc., without departing from the scope of this disclosure. It is also noted that the foregoing example digital playing cards are not meant to be limiting, and that the digital playing cards can correspond to any job position, real or hypothetical/experimental, without departing from the scope of this disclosure.

According to some embodiments, the computing device can identify the at least one digital playing card using any approach for effectively identifying an association between the at least one available job position and the at least one digital playing card. For example, the computing device can utilize at least one machine learning model that is trained to receive, as input, information about the at least one available job position, and to output information that, in turn, can be used to identify at least one existing digital playing card that corresponds to the at least one available job position. For example, when a given available job position relates to a crew chief position, the computing device can identify one or more digital playing cards representative of a crew chief position (or other similar position that relates thereto).

In some embodiments, the information can be used to generate at least one new digital playing card, which can be useful under scenarios in which there are no strong matches between the at least one available job position and existing digital playing cards that are selectable. For example, when a given available job position relates to a never-before-seen job position, information about the available job position can be provided to one or more machine learning models. In turn, the machine learning models can output information that can be used to form one or more digital playing cards that correspond to the available job position. This can involve, for example, deriving, from the information about the available job position, an image for the digital playing card, a title for the digital playing card, descriptive text for the digital playing card, game-related properties for the digital playing card, at least one task for obtaining the digital playing card, and so on. It is noted that the foregoing examples are not meant to be limiting, and that the digital playing card can be generated based on the information associated with the available job position—as well as any other available information—at any level of granularity, without departing from the scope of this disclosure.

According to some embodiments, the third method can include the step of (3) dynamically adjusting at least one property of the at least one digital playing card and/or the video game to increase a likelihood that players of the video game will be exposed to and acquire the at least one digital playing card. According to some embodiments, modifying the exposure of the at least one digital playing card can be implemented in accordance with the manner in which the digital playing cards and/or video game are designed. For example, if the at least one digital playing card includes a visibility property that influences an overall priority by which the at least one digital playing card is displayed, recommended, etc., to the players, then the visibility property can be assigned a value that increases the overall priority. In another example, if the video game includes a table that maintains a prioritized ordering of the digital playing cards, then the video game can be reconfigured to artificially increase the prioritization of the at least one digital playing card within the table. It is noted that the foregoing examples are not meant to be limiting, and that any conceivable approach that effectively increases a likelihood that players of the video game will be exposed to the digital playing card can be implemented without departing from the scope of this disclosure.

According to some embodiments, modifying the acquisition requirements for the at least one digital playing card can be implemented in accordance with the manner in which the digital playing cards and/or video game are designed. For example, if the task for acquiring the at least one digital playing card involves watching a three (3) minute video, then the task/video can be modified so that the players are required to watch only a one (1) minute version of the video. In another example, if the task for acquiring the at least one digital playing card involves answering a ten (10) question quiz, then the task/quiz can be modified so that the players are required to answer only three (3) questions in the quiz. In yet another example, if the task for acquiring the at least one digital playing card involves completing a difficult simulation, then the overall difficulty of the simulation can be reduced so that the players have an easier time completing the simulation. It is noted that the foregoing examples are not meant to be limiting, and that any approach that can be used to modify the acquisition requirements for the at least one digital card can be implemented without departing from the scope of this disclosure.

Additionally, the third method can include the step of (4) dynamically adjusting at least one property of at least one available mission within the video game to increase a likelihood that players of the video game will be exposed to and pursue the at least one available mission. This can be beneficial when the utilization of the at least one digital playing card, when pursuing the at least one available mission, increases a likelihood of achieving the at least one available mission. For example, if a given mission requires (or benefits significantly from) the utilization of the at least one digital playing card, then the computing device can, using any feasible approach, artificially promote the mission. In this manner, the players will be incentivized to acquire and/or utilize the digital playing card—which, as described herein, is linked to the at least one available job position—thereby potentially increasing the players' exposure to the at least one available job position.

Additionally, the third method can include the step of (5) dynamically adjusting at least one property of at least one building structure goal within the video game to increase a likelihood that players of the video game will be exposed to and pursue the at least one building structure goal. This can be beneficial when the utilization of the at least one digital playing card when pursuing the at least one building structure goal increases a likelihood of achieving the at least one building structure goal. For example, if a given building goal requires (or benefits significantly from) the utilization of the at least one digital playing card, then the computing device can, using any feasible approach, artificially promote the building goal. In this manner, the players will be incentivized to acquire and/or utilize the digital playing card—which, as described herein, is linked to the at least one available job position—thereby potentially increasing the players' exposure to the at least one available job position.

It is noted that the foregoing adjustments are not limited to mission and building structure goals, and that any form of activity available through the video game can be modified, in any fashion and level of granularity, to effectively promote the at least one available job position.

Additionally, the third method can include the steps of (6) identifying at least one player of the video game having a respective recruitment profile indicative of an interest in the at least one available job position, and (7) causing information about the at least one digital playing card to be presented to the at least one player. This approach can be beneficial in that it exposes (by way of the at least one digital playing card), to at least one player that has already shown an interest in the at least one available job position (or others like it), various aspects of the at least one available job position, which can potentially help bolster the player's established interest in such available job positions. The acquisition of the at least one digital playing card can also enable the player to excel when pursuing in-game activities that benefit from the utilization of the at least one digital playing card, which also can potentially help bolster the player's established interest in such available job positions.

Additionally, the third method can include the steps of (8) identifying at least one player of the video game having a respective recruitment profile indicative of no exposure to content within the video game related to the at least one available job position, and (9) causing information about the at least one digital playing card to be presented to the at least one player. This approach can also be beneficial in that it exposes (by way of the at least one digital playing card), to at least one player that has not shown an interest in the at least one available job position (or others like it), various aspects of the at least one available job position, which can potentially help establish the player's interest in job positions to which the player has not yet been exposed. The acquisition of the at least one digital playing card can also enable the player to excel when pursuing in-game activities that benefit from the utilization of the at least one digital playing card, which also can potentially help establish the player's interest in such available job positions.

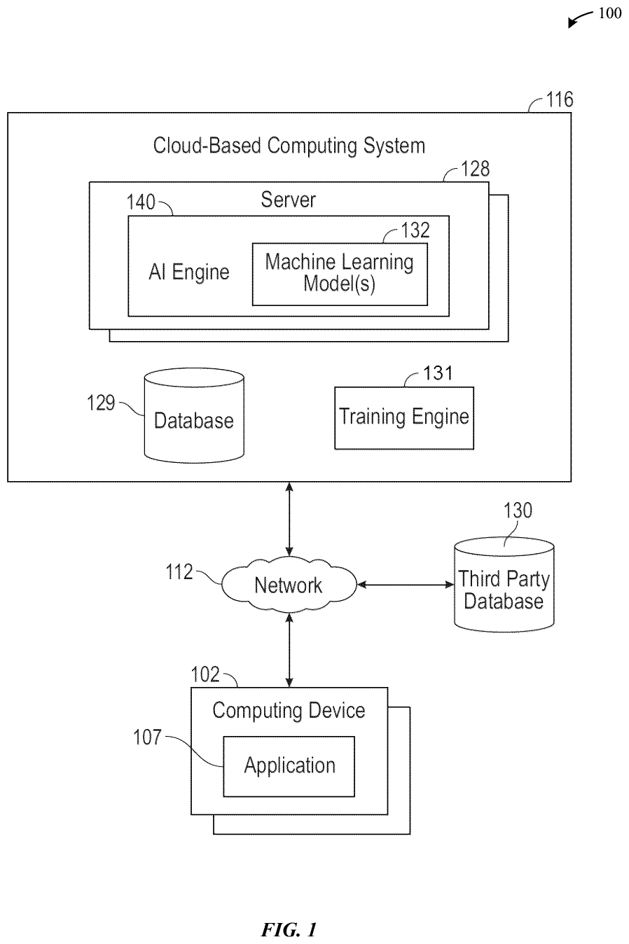

A more detailed description of the foregoing techniques will now be provided below in conjunction with FIGS. 1, 2A-2P, and 3-6.

To explore the foregoing in more detail, FIG. 1 will now be described. FIG. 1 illustrates a high-level component diagram of an illustrative system architecture 100 according to certain embodiments of this disclosure. In some embodiments, the system architecture 100 may include computing devices 102, a cloud-based computing system 116, and/or a third-party database 130 that are communicatively coupled via a network 112. As used herein, a cloud-based computing system refers, without limitation, to any remote or distal computing system accessed over a network link. Each of the computing devices 102 may include one or more processing devices, memory devices, and network interface devices.

The network interface devices of the computing devices 102 may enable communication via a wireless protocol for transmitting data over short distances, such as Bluetooth, ZigBee, near field communication (NFC), etc. Additionally, the network interface devices may enable communicating data over long distances, and in one example, the computing devices 102 may communicate with the network 112. Network 112 may be a public network (e.g., connected to the Internet via wired (Ethernet) or wireless (WiFi)), a private network (e.g., a local area network (LAN), wide area network (WAN), virtual private network (VPN)), or a combination thereof.

The computing device 102 may be any suitable computing device, such as a laptop, tablet, smartphone, virtual reality device, augmented reality device, or computer. The computing device 102 may include a display that is capable of presenting a user interface of an application 107. As one example, the computing device 102 may be operated by potential recruits for available job positions (as will be described in greater detail herein). The application 107 may be implemented through computer instructions stored on a memory of the computing device 102 and executed by a processing device of the computing device 102. Alternatively, the application 107 may be implemented as a web browser that is configured to obtain interpretable content to be displayed through the web browser. It is noted that the foregoing examples are not meant to be limiting, and that the application 107 can be implemented using any platform/approach without departing from the scope of this disclosure.

According to some embodiments, the application 107 can take the form of a video game that is configured to provide an interactive environment that exposes players the various considerations associated with real-world job positions. For example, when the video game pertains to a military environment, the video game can task players with building and maintaining structures on a military base, carrying out missions, and so on. In another example, when the video game pertains to a racing environment (e.g., car racing, motorcycle racing, boat racing, etc.), the video game can task players with building and maintaining racing vehicles, managing logistical challenges involved in traveling to races, and so on. In yet another example, when the video game pertains to a farming environment, the video game can task players with building and maintaining structures on farms, cultivating crops, managing logistical challenges involved in storing and selling products, and so on. It is noted that the foregoing examples are not meant to be limiting, and that the application 107 can take the form of any video game, configured to provide any interactive environment, without departing from the scope of this disclosure.

According to some embodiments, the application 107 can utilize any approach to effectively implement an environment and to task the players with different activities. According to some embodiments, the application 107 can implement digital playing cards that are tied to real-world (or hypothetical/experimental) job positions. For example, a given digital playing card can include any type/number of properties that effectively correlate the digital playing card to an aircraft mechanic. Such properties can include, for example, an image for the digital playing card, a title for the digital playing card, descriptive text for the digital playing card, game-related properties for the digital playing card, at least one task for obtaining the digital playing card, and so on. It is noted that the foregoing examples are not meant to be limiting, and that the digital playing cards described herein can be implemented in any fashion that effectively correlates the digital playing cards to job positions.

According to some embodiments, the digital playing cards can influence the manner in which various activities within the video game are carried out. According to some embodiments, a player can possess a collection of digital playing cards, yet only be allowed to actively utilize a subset of the digital playing cards in the collection. This limitation can be beneficial in that it requires the player to make intelligent and informed decisions about the digital playing cards that should be collected and activated when pursuing different activities in the game.

In one example, the building/management of a given structure may require and/or benefit from the possession of particular digital playing cards. In a similar vein, the overall efficiency/effectiveness by which the building operates may require and/or benefit from the possession of particular digital playing cards. In another example, access to a particular mission may require and/or benefit from the possession of particular digital playing cards. According to some embodiments, a given mission may be automatically/semi-automatically implemented based on the digital playing cards of which the player is in possession. For example, a given mission may be simulated from start to finish with no interaction required of the player, with intermittent interaction required by the player, or with constant interaction required by the player.

Turning back now to FIG. 1, in some embodiments, the cloud-based computing system 116 may include one or more servers 128 that form a distributed, grid, and/or peer-to-peer (P2P) computing architecture. Each of the servers 128 may include one or more processing devices, memory devices, data storage, and/or network interface devices. The servers 128 may execute an AI engine 140 that uses one or more machine learning models 132 to perform at least one of the embodiments disclosed herein. The servers 128 may be in communication with one another via any suitable communication protocol. In some embodiments, the cloud-based computing system 116 may include a database 129. The cloud-based computing system 116 may also be connected to a third-party database 130. The database 129 and/or 130 may store data pertaining to available job positions that employers are seeking to fill. In this regard, the data can include any information, at any level of granularity, that may be utilized to effectively match potential candidates to the job positions using the various techniques described herein.

The cloud-based computing system 116 may include a training engine 131 capable of generating and maintaining one or more machine learning models 132. Although depicted separately from the AI engine 140, the training engine 131 may, in some embodiments, be included in the AI engine 140 executing on the server 128. In some embodiments, the AI engine 140 may use the training engine 131 to generate the machine learning models 132 trained to perform inferencing operations, predicting operations, determining operations, controlling operations, and the like. The one or more machine learning models 132 may be generated by the training engine 131 and may be implemented in computer instructions executable by one or more processing devices of the training engine 131 or the servers 128. To generate the one or more machine learning models 132, the training engine 131 may train the one or more machine learning models 132.

The training engine 131 may be a rackmount server, a router, a personal computer, a portable digital assistant, a smartphone, a laptop computer, a tablet computer, a netbook, a desktop computer, an Internet of Things (IoT) device, any other desired computing device, or any combination of the above. The training engine 131 may be cloud-based, be a real-time software platform, include privacy software or protocols, or include security software or protocols.

The one or more machine learning models 132 may refer to model artifacts created by the training engine 131 using training data that includes training inputs and corresponding target outputs. The training engine 131 may find patterns in the training data wherein such patterns map the training input to the target output and generate the machine learning models 132 that capture these patterns. Although depicted separately from the server 128, in some embodiments, the training engine 131 may reside on server 128. Further, in some embodiments, the artificial intelligence engine 140, the database 150, or the training engine 131 may reside on the computing device 102.

According to some embodiments, the one or more machine learning models 132 may comprise, e.g., a single level of linear or non-linear operations (e.g., a support vector machine (SVM)) or the machine learning models 132 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each artificial neuron may transmit its output signal to the input of the remaining neurons, as well as to itself). For example, the machine learning model may include numerous layers or hidden layers that perform calculations (e.g., dot products) using various neurons. In some embodiments, one or more of the machine learning models 132 may be trained to use causal inference and counterfactuals.

For example, the machine learning model 132 trained to use causal inference may accept one or more inputs, such as (i) assumptions, (ii) queries, and (iii) data. The machine learning model 132 may be trained to output one or more outputs, such as (i) a decision as to whether a query may be answered, (ii) an objective function (also referred to as an estimand) that provides an answer to the query for any received data, and (iii) an estimated answer to the query and an estimated uncertainty of the answer, where the estimated answer is based on the data and the objective function, and the estimated uncertainty reflects the quality of data (i.e., a measure which takes into account the degree or salience of incorrect data or missing data). The assumptions may also be referred to as constraints and may be simplified into statements used in the machine learning model 132. The queries may refer to scientific questions for which the answers are desired.

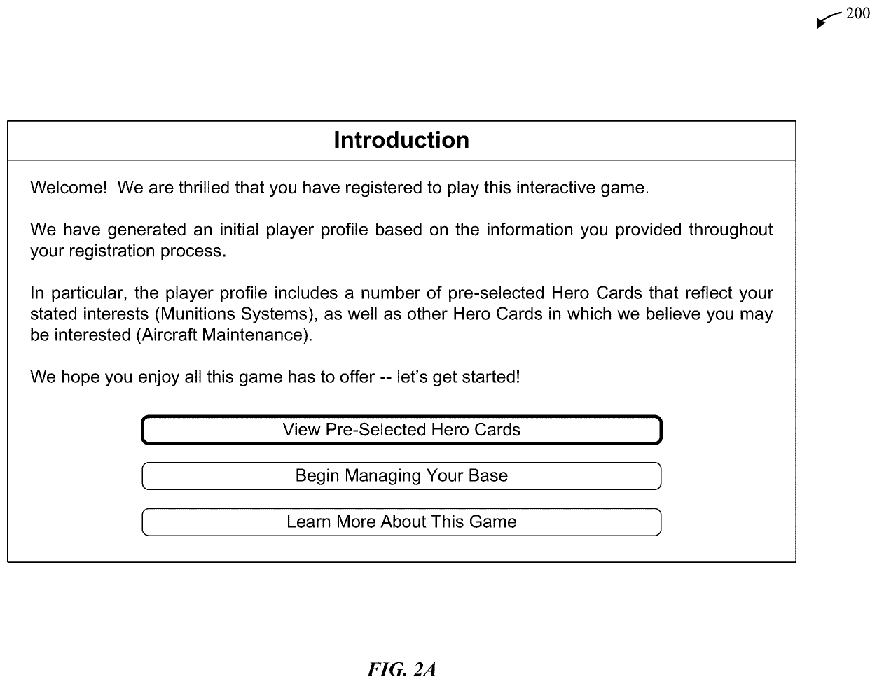

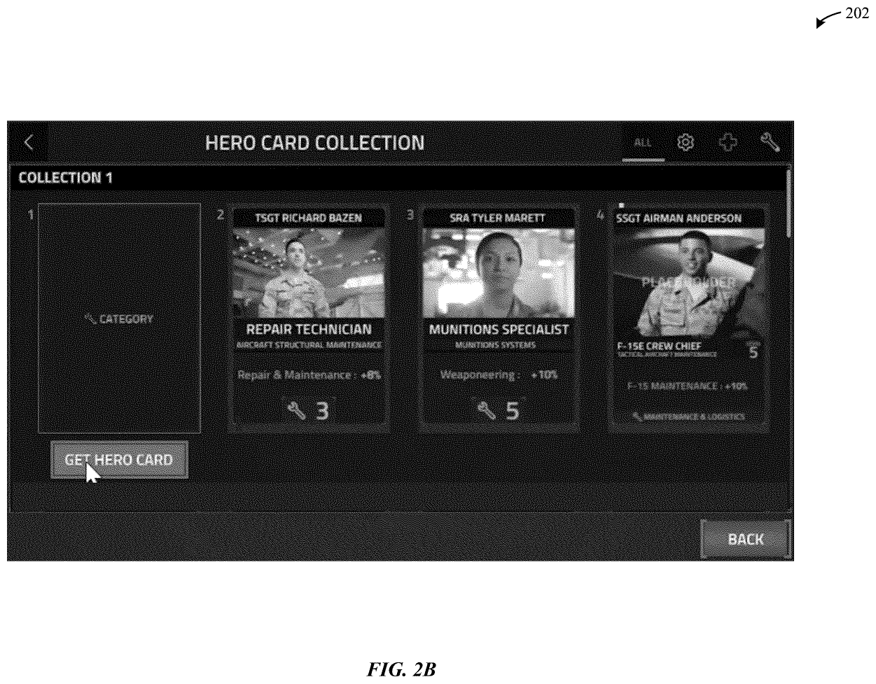

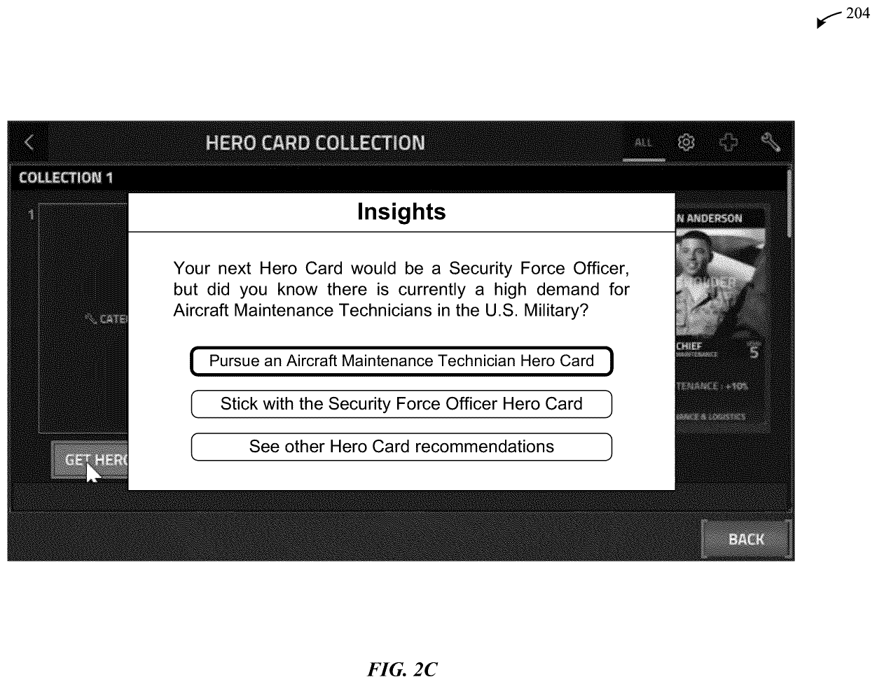

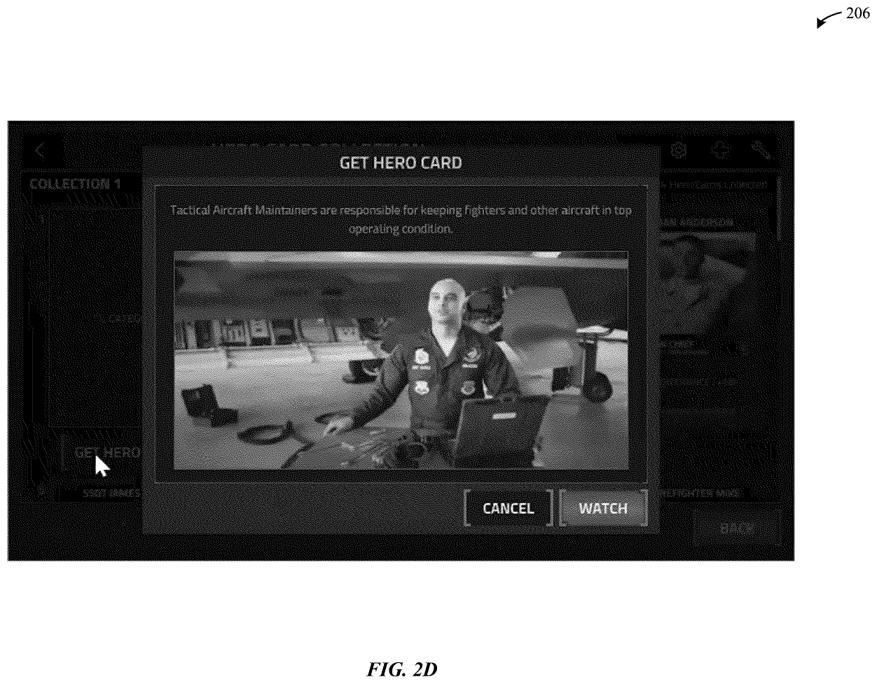

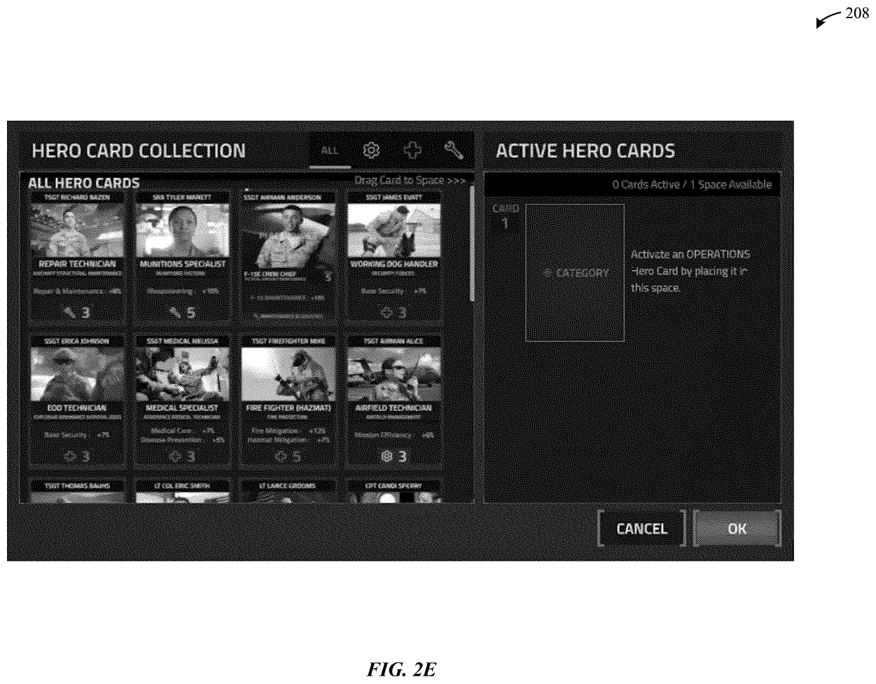

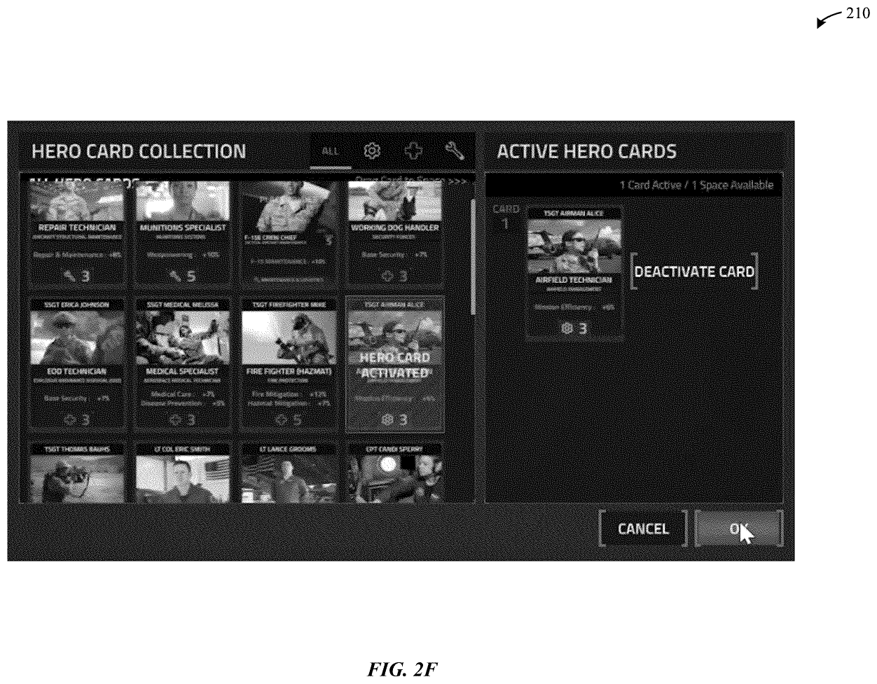

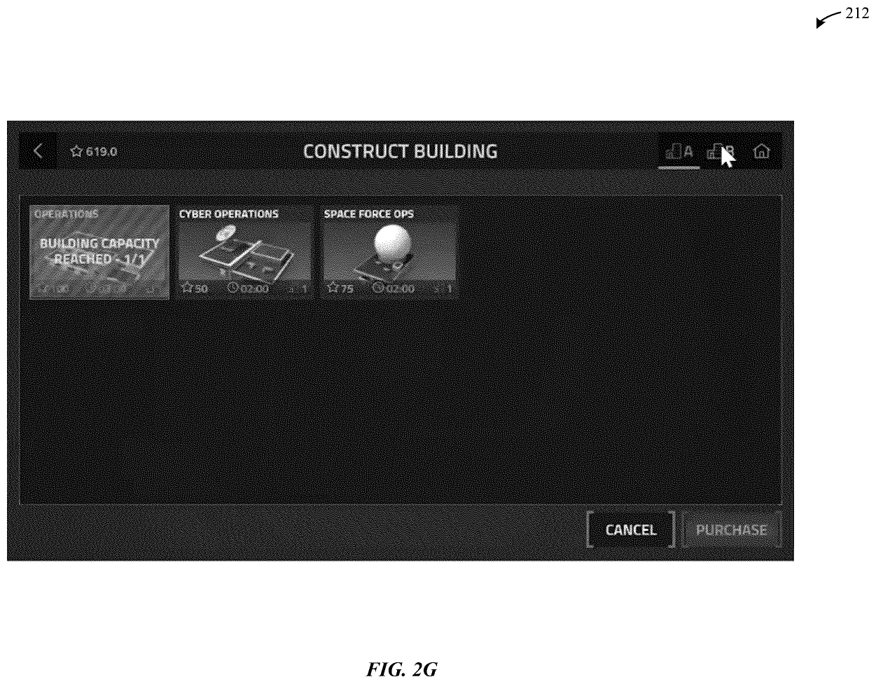

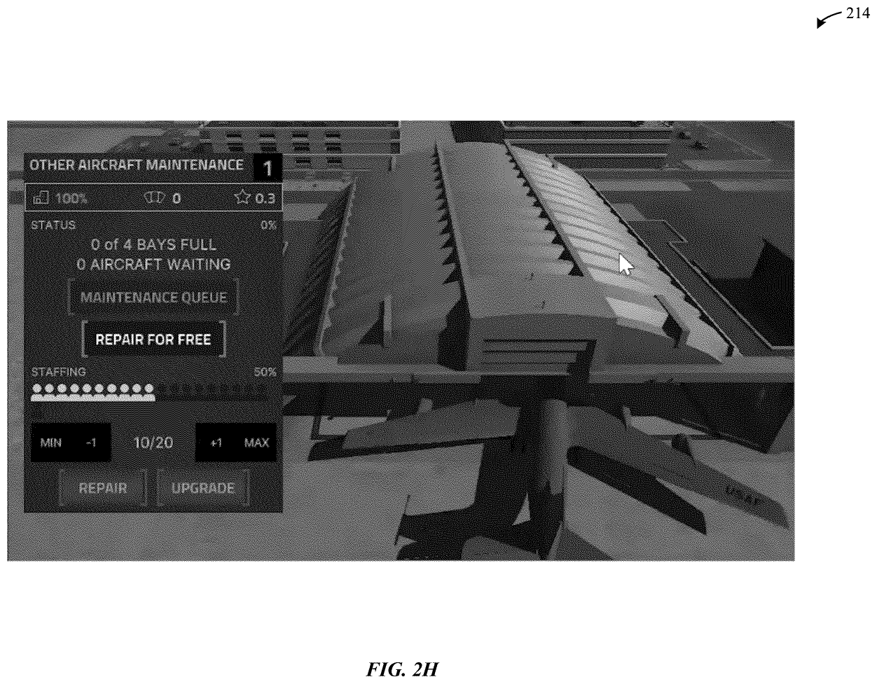

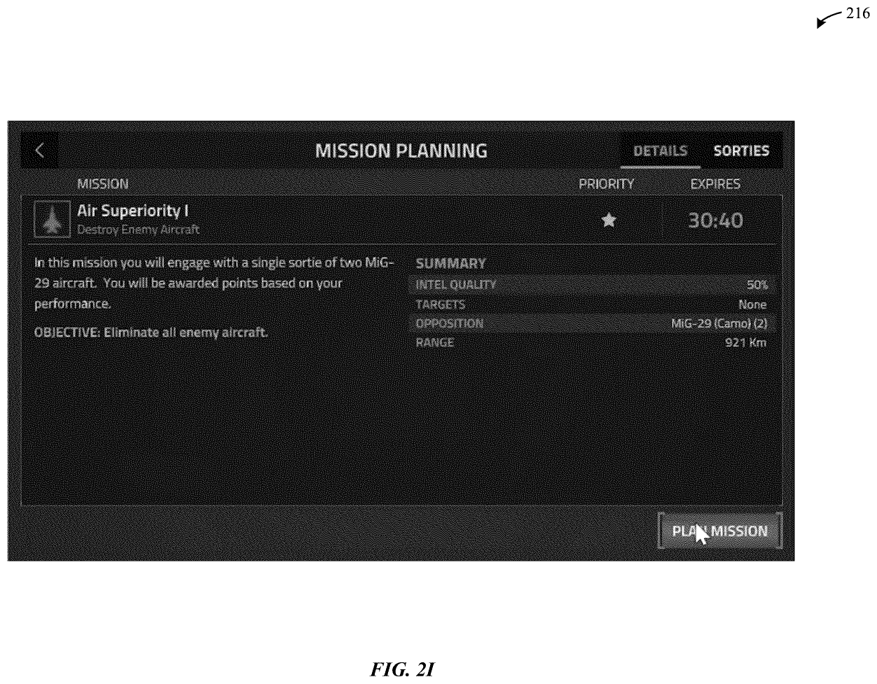

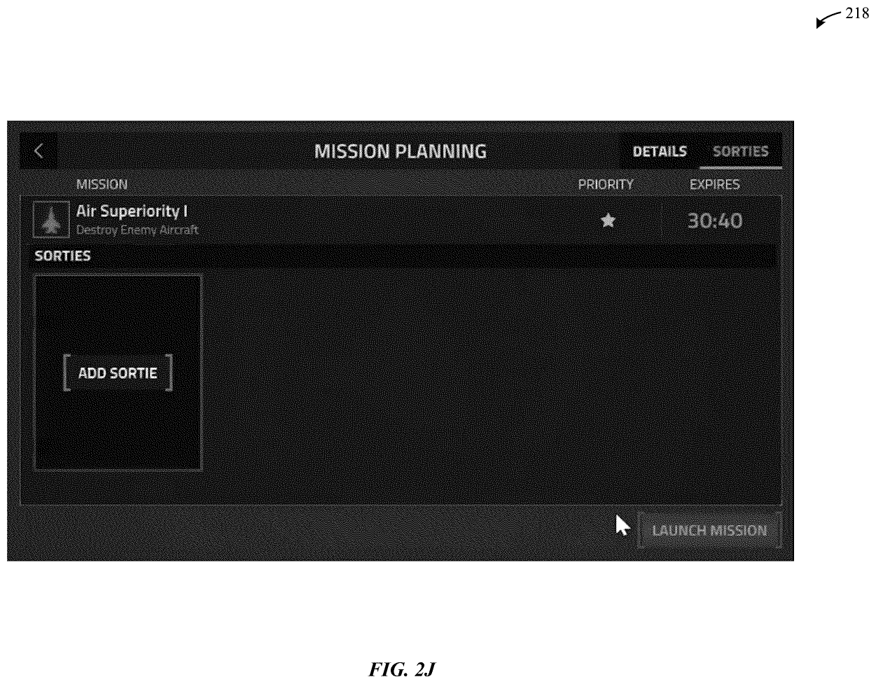

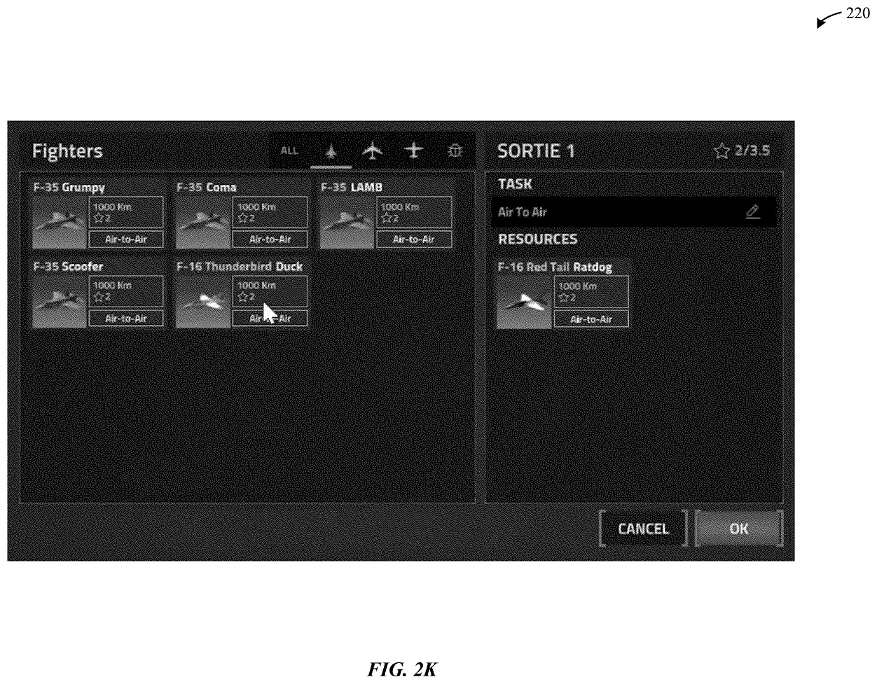

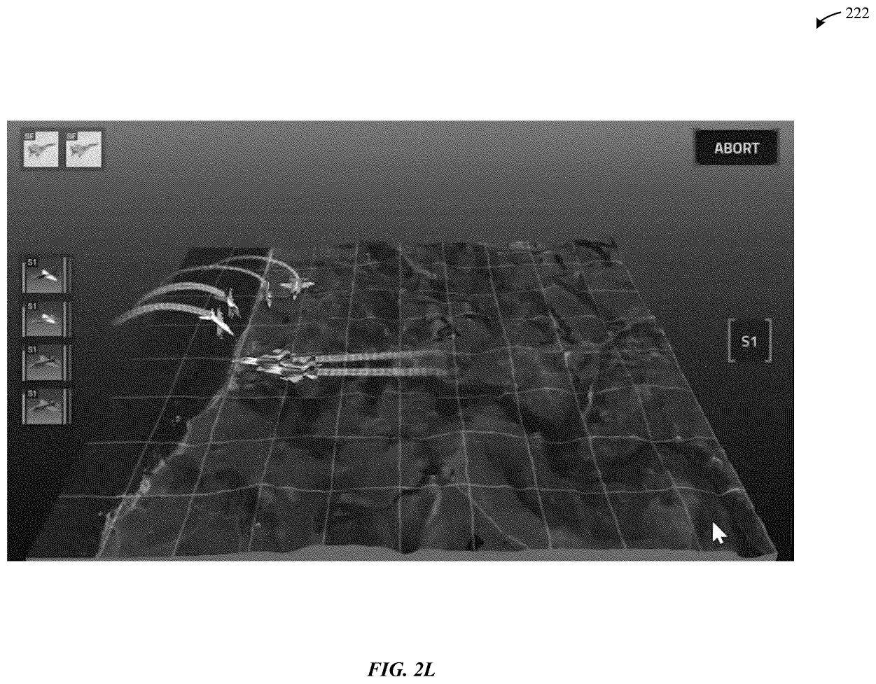

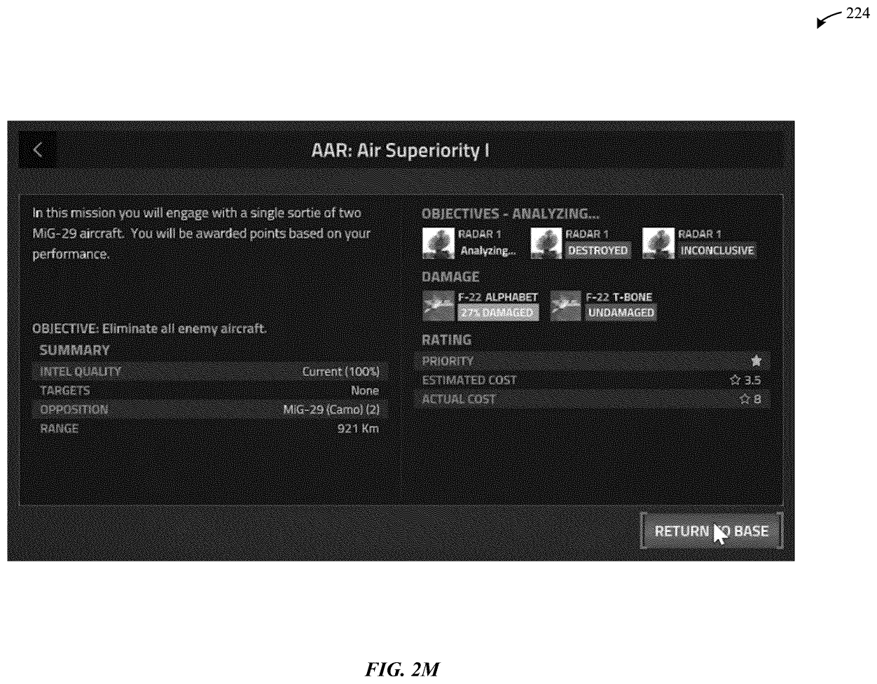

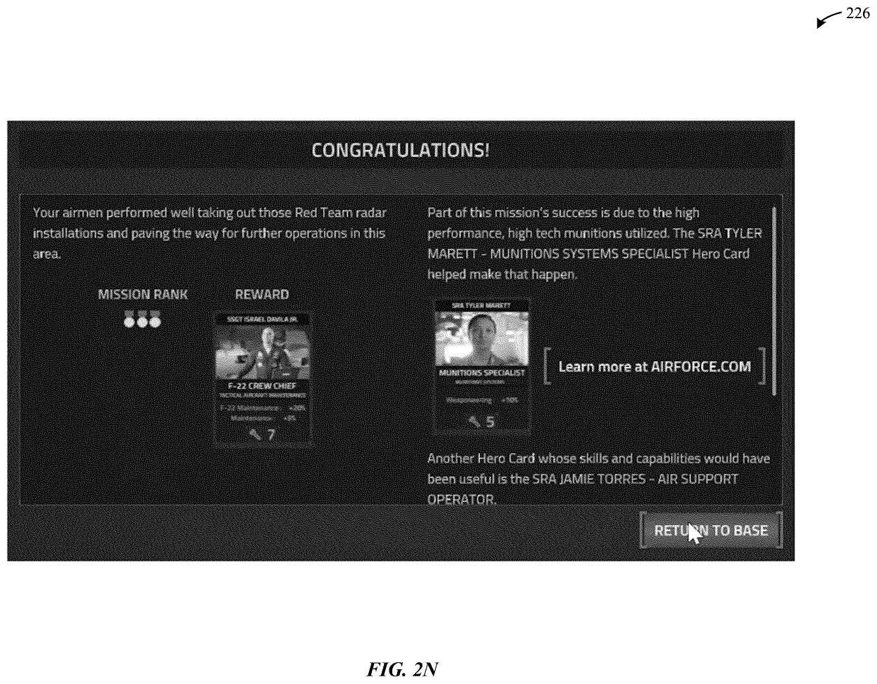

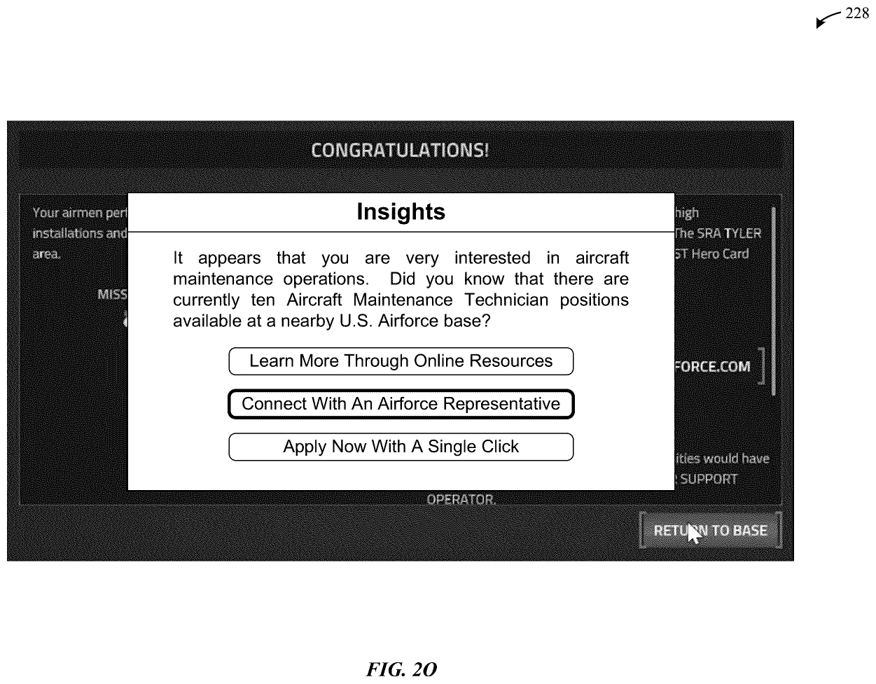

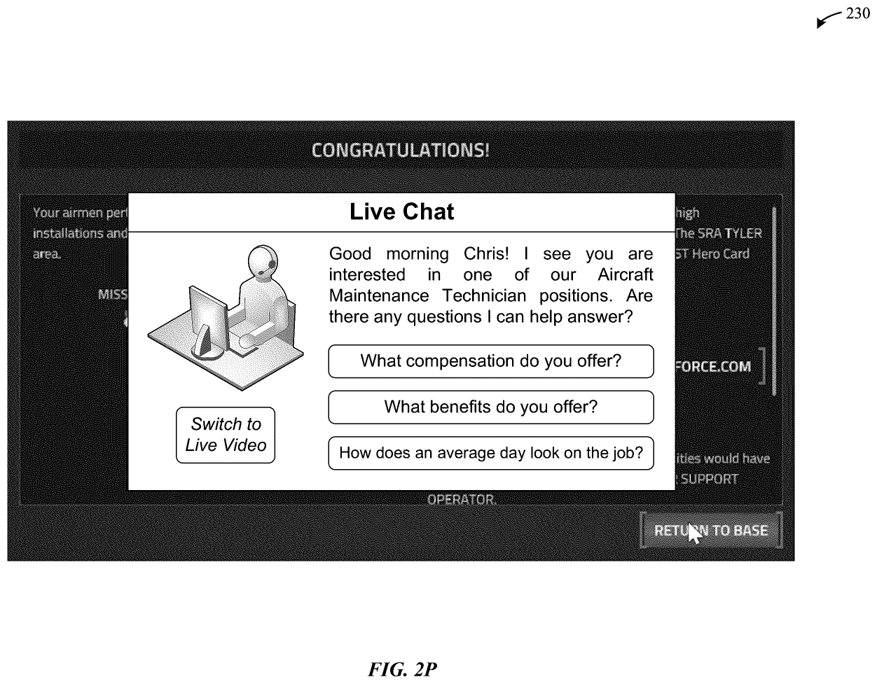

FIGS. 2A-2P illustrate conceptual diagrams of example user interfaces that are displayed to a player throughout their hypothetical engagement with the application 107, according to some embodiments. In the examples illustrated throughout FIGS. 2A-2P, the application 107—also referred to herein as the “video game”—pertains to military operations. In particular, FIG. 2A illustrates a conceptual diagram 200 of a welcome screen that can be displayed to a new player after loading the application 107. As shown in FIG. 2A, an initial player profile (also referred to herein as a “recruitment profile”) is generated based on information that the player provided during a registration process. The information-which is referred to herein as “characteristic information”—can include, for example, information submitted by the player throughout communications with a recruitment entity (e.g., a military recruitment center, a job matching agency, etc.) and that is accessible to the video game. The information can also include information provided by the player during a registration process associated with the video game. The information can also include publicly-available information about the player (e.g., social media postings, public records, etc.). It is noted that the foregoing examples are not meant to be limiting, and that any information about the player can be obtained using any approach, without departing from the scope of this disclosure.

The application 107 can utilize one or more of the various techniques described herein to generate the recruitment profile based on the information. For example, the application 107 can provide the information to one or more machine learning models that output the recruitment profile (or information from which the recruitment profile can be derived). According to some embodiments, the recruitment profile is associated with a number of digital playing cards (referred to in FIG. 2A and herein as “Hero Cards”). The application 107 utilizes one or more of the various techniques described herein when selecting the digital playing cards to assign to the recruitment profile. For example, the selection can be based on the information about the player, on information about other players, on information about available job positions that require fulfillment, and so on.

As shown in FIG. 2A, the user interface provides an option for the player to view the pre-selected Hero Cards that are part of their recruitment profile, and the player selects the option. In turn, the user interface is updated in accordance with the conceptual diagram 202 illustrated in FIG. 2B. As shown in FIG. 2B, the player's Hero Card collection includes a Hero Card for a repair technician, a Hero Card that relates to a munitions specialist, and a Hero Card that relates to a crew chief. These Hero Cards can be preassigned, for example, when the player primarily exhibits an interest in maintenance activities, as well as a curiosity about the management of munitions. Alternatively (or additionally), the Hero Cards can be preassigned when information about available job positions indicates a heightened need for maintenance technicians (and, optionally, munitions technicians), which can be determined using the various techniques herein.

As shown in FIG. 2B, the user interface provides an option for the player to obtain additional Hero Cards, and the player selects the option. In turn, the user interface is updated in accordance with the conceptual diagram 204 illustrated in FIG. 2C. As shown in FIG. 2C, under normal/unbiased circumstances, the video game would normally provide a next Hero Card that corresponds to a security force officer. However, as discussed herein, different aspects associated with a particular available job-such as a fulfillment urgency, a high demand (e.g., a large number of open positions), and so on—can cause the video game to promote Hero Cards that will expose players to the available job and potentially increase their interest in pursuing it. An example of this scenario is captured in FIG. 2C, where the video game suggests that the player pursue an aircraft maintenance technician Hero Card (instead of the security force officer Hero Card).

As shown in FIG. 2C, the player opts to pursue the aircraft maintenance technician Hero Card. In turn, the user interface is updated in accordance with the conceptual diagram 206 illustrated in FIG. 2D. As shown in FIG. 2D, the task of watching an informational video about tactical aircraft maintainers is required to be completed in order for the player to obtain the Hero Card. As described herein, the task of watching a video (instead of some other task) can be assigned based on a prediction that the player is most likely to engage in and complete tasks that are video-related. As described herein, the prediction can be based on, for example, a determination that video-based tasks are connected to the highest completions relative to acquiring the particular Hero Card, a determination that the player exhibits a preference for video-based tasks, a determination that video-based tasks are the most effective approach to educating players about tactical aircraft maintenance, and so on. It is noted that the foregoing examples are not meant to be limiting, and that the prediction can be based on any information/analyses thereof without departing from the scope of this disclosure.

In the scenario illustrated in FIG. 2D, the player opts to watch the video and satisfies the requirements for completing the video. According to some embodiments, the video game can monitor the manner in which the player carries out the task at hand to enable a variety of useful determinations to be made. Such determinations can include, for example, whether the player has satisfactorily completed the task. For example, if the task involves watching a video, the task can be deemed to be satisfactorily completed when seventy-five (75%) of the video has been watched. In another example, if the task involves completing a simulation, the task can be deemed to be satisfactorily completed when a number of checkpoints, accomplishments, etc., have been completed. The determinations can also include analyzing the player's overall attention span/engagement with the task. For example, when the task involves watching a video, the video game can monitor whether the player remains engaged or has switched to other software applications on the computing device 102 while the video plays in the background. In another example, if the task involves completing a simulation, the video game can monitor the player's interactions (e.g., mouse inputs, keyboard inputs, audio/video inputs (where privacy considerations are addressed), etc.) with the simulation to determine whether the player is interested in the simulation, disinterested in the simulation, frustrated by the simulation, and so on. Such monitoring can produce information that can be used to dynamically modify the video game to assign tasks to that are most conducive to the players' interests, skillsets, weaknesses, and so on.

FIG. 2E illustrates a conceptual diagram 208 of a user interface that is displayed both subsequent to the player completing the task to acquire the repair technician Hero Card, as well as subsequent to the player completing other tasks to acquire other Hero Cards (i.e., a working dog handler Hero Card, an explosive ordinance disposal Hero Card, a medical specialist Hero Card, a firefighter Hero Card, an airfield technician Hero Card, and other Hero Cards). As shown in FIG. 2E, the video game (initially) provides a single slot for the player to activate (i.e., utilize) a Hero Card of their choice. It is noted that, as the player advances through the video game, additional slots can be opened to enable the player to activate other Hero Cards of their choosing. The additional slots can be opened, for example, when threshold numbers of Hero Cards are acquired, when threshold numbers of accomplishments are satisfied (e.g., building structures, carrying out missions, obtaining virtual currencies, etc.), and so on. In the scenario illustrated in FIG. 2E, the player activates the airfield technician Hero Card, and the resulting user interface is illustrated in the conceptual diagram 210 of FIG. 2F.

As described herein, active Hero Cards can influence various aspects with respect to how the video game operates. For example, a given Hero Card can enable the player to build a particular structure, to carry out a particular mission, and so on. In another example, a given Hero Card can influence the manner(s) in which structures operate, the manner(s) in which missions are carried out, and so on. For example, a structure that is designed to repair aircraft can operate more efficiently when one or more Hero Cards related to aircraft maintenance are active. In another example, a mission that involves dog fighting enemy aircraft can be more likely to succeed when Hero Cards related to highly skilled fighter pilots are active. Additionally, combinations of two or more Hero Cards can influence the manner in which each Hero Card, in isolation, would otherwise affect the mechanics of the video game. For example, combining activating two aircraft technician Hero Cards can artificially boost the effects of the Hero Cards, which reflects the real-world benefits that might be seen when two aircraft technicians are able to share knowledge, assist one another, and so on. It is noted that the foregoing examples are not meant to be limiting, and that the Hero Cards can influence the manner in which the video game operates, in any fashion and at any level of granularity, without departing from the scope of this disclosure.

FIG. 2G illustrates a conceptual diagram 212 of a user interface that is displayed when the player selects an option to construct a building. As described herein, various aspects of the game can affect the buildings that the player is permitted to construct, such as Hero Cards acquired/activated, achievements accomplished in the game, the number/type of buildings that have already been constructed, available land on which the buildings can be constructed, available balances of virtual currencies, and so on. These mechanics are reflected in the user interface illustrated in FIG. 2G, which (1) prohibits the construction of a general operations building (as a limit of one general operations building has already been satisfied), but (2) permits the construction of cyber operations building or a space force operations building. In turn, the player can pursue building the cyber operations building or the space force operations building, or simply opt not to building a new structure and instead return to other gameplay.

FIG. 2H illustrates a conceptual diagram 214 of a user interface that is displayed when the player selects an option to view the status of an aircraft maintenance building that the player opted to construct at some point while playing the video game. As shown in FIG. 2H, the user interface can display various properties associated with the building, such as the number of airplanes the building is capable of accommodating for repair, the number of airplanes waiting to be repaired, the overall staffing level of the building, and so on. The user interface can also enable the player to repair or upgrade the building. According to some embodiments, and as described herein, these properties/options can be influenced by the Hero Cards that have been acquired/are active, by balances of virtual currencies in the game, by other buildings that have been constructed (as well as the manner(s) in which they are operating), and so on. For example, activating aircraft maintenance technician Hero Cards (or similar/applicable Hero Cards) can increase the staffing property associated with the building, which can increase the speed at which the building is able to repair aircraft, alter/enhance the upgrades that are available, and so on. In another example, activating building maintenance technician Hero Cards (or similar/applicable Hero Cards) can influence available repair operations, the rate at which repairs are made, the quality of the repairs, and so on. It is noted that the foregoing examples are not meant to be limiting, and that the manner(s) in which buildings operate can be based on any number of factors, conditions, etc., at any level of granularity, without departing from the scope of this disclosure.

FIG. 2I illustrates a conceptual diagram 216 of a user interface that is displayed when the player selects an option to carry out an air superiority mission. As shown in FIG. 2I, the user interface provides information about the mission, such as a detailed description, an objective, a summary, and other information. The user interface also provides an option for the player to plan out the manner in which they would like to carry out the mission-which, as shown in FIG. 2I, includes an option to add sorties. FIGS. 2J/2K illustrate conceptual diagrams 218/220 of user interfaces that are displayed when the player selects the option to plan out the mission/add sorties. As shown in FIG. 2K, the user interface enables the player to select various aircraft that are available to the player, such as aircraft that are available to the player by default, aircraft acquired by the player through different accomplishments, and so on. In the scenario captured by FIG. 2K, the player selects an F-16 Red Tail Ratdog aircraft, as well as three other aircraft (not illustrated in the Task window depicted in FIG. 2K). The player subsequently opts to carry out the mission using the selected aircraft.

FIG. 2L illustrates a conceptual diagram 222 of a user interface that is displayed as the mission is carried out. As described herein, the mission can be implemented in any fashion, such as automatically, semi-automatically, and so on. For example, the manner in which an automatic mission is played out may depend on the selected aircraft, the activated Hero Cards, and so on. In another example, the manner in which a semi-automatic mission is played out may depend on the same foregoing aspects, and may further depend on player inputs throughout the mission, such as decisions, controls, and so on. FIGS. 2M/2N illustrate conceptual diagrams 224/226 of user interfaces that are displayed after the mission is completed. As shown in FIGS. 2M/2N, the user interfaces include summaries of various results of the mission. In particular, the user interface depicted in FIG. 2N highlights active Hero Cards that influenced the playout of the mission. The user interface depicted in FIG. 2N also highlights unacquired or inactive Hero Cards that, if active during the mission, would have benefitted the mission. These informational aspects beneficially inform the user of the values of different job roles and how they affect the operations of real-world activities. Such knowledge can increase a given player's interest in one or more job positions in the game, which may ultimately draw the player to equivalent job positions in the real world.

FIG. 2O illustrates a conceptual diagram 228 of a user interface that is displayed in conjunction with the post-mission results displayed in FIGS. 2M/2N. As shown in FIG. 2O, the video game indicates that it has determined the player is interested in maintenance aircraft operations. As described herein, such a determination can be made by monitoring Hero Card acquisitions/activations, building activities, mission activities, virtual currency expenses, and so on. Additionally, and as described herein, the video game can identify one or more available job positions that are relevant to the player's interest-which, as shown in FIG. 2O, includes aircraft maintenance technician positions that are open at a nearby U.S. Airforce base. As shown in FIG. 2O, the player is presented with options to learn more about the available job positions through online resources (e.g., informational web pages, informational videos, informational software applications, etc.), or through connecting with a recruitment representative (e.g., by text, email, chat, phone call, virtual assistant, etc.).

Additionally, and as shown in FIG. 2O, the user interface enables the player to apply to the job with a single click. According to some embodiments, a selection of this option can enable the player to upload a resume. The video game can also dynamically generate a resume that is prefilled with information about the player that is accessible to the video game and/or derived by the video game based on the player's interactions with the video game. For example, the resume can be pre-filled with characteristic information about the player that is relevant to resumes that are typically submitted to the U.S. Airforce, such as basic demographic information. The resume can also be pre-filled with experience, knowledge, and/or skillset information that is derived from the player's interactions with the video game. For example, the video game can identify quizzes—such as those tied to acquiring Hero Cards related to aircraft maintenance operations—where the player exhibited exemplary knowledge, and generate/inject a summary of the knowledge into the resume. In another example, the video game can identify base management operations performed by the player that are indicative of one or more skills that are relevant to aircraft maintenance operations, and generate/inject a summary of the performance into the resume. In yet another example, the video game can identify mission operations pursued by the player that are indicative of one or more skills that are relevant to aircraft maintenance operations—such as the player's awareness that taking the necessary steps (e.g., aircraft maintenance Hero Card activations) to repair aircraft immediately after missions is essential to managing a thriving and effective military operation. It is noted that the foregoing examples are not meant to be limiting, and that any information can be analyzed, at any level of granularity, to assist the player in developing a resume that can be used to apply for one or more of the available job positions. In any case, when the resume is finalized by the player, and the submission is approved by the player, the video game can distribute the resume to the appropriate entities.

It is noted that the video game can implement a variety of approaches to increase an overall likelihood that the player engages with the option to apply to one or more available job positions. For example, the video game can identify, based on the recruitment profile of the player, perks of the one or more available job positions that likely are important to the player—such as health benefits, retirement benefits, tuition benefits, relocation package benefits, ascension potential, and so on. In turn, the video game can emphasize the relevant perks when notifying the player about the available job positions. For example, if the player opts to learn more information through online resources—e.g., a web page—then the video game can, prior to displaying the information, highlight portions of the information that likely are important to the player. In another example, when the online resources include watching a video, the video can be dynamically modified such that content pertaining to the identified perks is prioritized, emphasized, etc., during playback of the video.

In another example, if the player opts to connect with a virtual recruiter through an online chat interface, then the chat interface can be preloaded with options that enable the player to obtain information in which they are most likely interested. An example of this approach is illustrated in the conceptual diagram 230 of FIG. 2P. In this example, the video game has identified that the player is primarily interested in compensation, and secondarily interested in benefits. Such a determination can be made, for example, when the player exhibits a high level of earning and spending virtual currencies to advance through the video game (as opposed to, for example, completing tasks). In other example, the determination is made when the player resides in an area with a high cost of living. In yet another example, the same determination can be made based on identifying that the player primarily focuses on compensation information included in Hero Cards (e.g., immediately navigating to such information each time a new Hero Card is acquired). It is noted that information about the player's interests can also be provided in advance to a recruiter. In this manner, the recruiter can obtain an understanding of where to focus when discussing the job with the player, thereby increasing the likelihood of garnering the player's interest in applying for the job position. For example, if the recruiter is notified that the player has exhibited an interest in attending graduate school, then the recruiter will know to focus on tuition reimbursement perks that may be provided through the job position. It is noted that the foregoing examples are not meant to be limiting, and that any information can be analyzed, at any level of granularity, to effectively identify a way to approach the player in a manner that maximizes a likelihood that the player will apply for and pursue the job position.

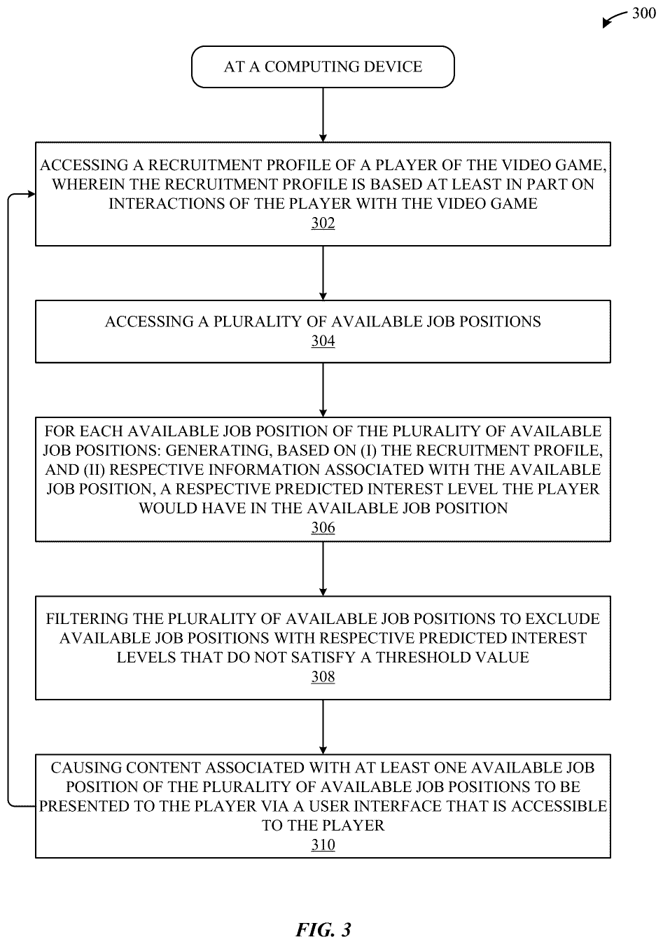

Accordingly, FIGS. 2A-2P illustrate various user interfaces of a video game that enable a given player to engage with different job roles involved in managing a military base and military operations. In turn, the video game can identify available job positions that need fulfilment, would be of interest to the player, etc., and present information about the job positions to the player in a convenient manner. Again, it is noted that the embodiments are not limited to the military environment depicted in FIGS. 2A-2P and described throughout this disclosure. On the contrary, the embodiments are applicable to any environment that can be configured to educate players about job positions and all that they entail. Additionally, FIGS. 3-5 provide different methods that constitute abstracted descriptions of the detailed techniques set forth herein, which are described below in greater detail.

FIG. 3 illustrates a method 300 for promoting available job positions to players of a video game, according to some embodiments. As shown in FIG. 3, the method 300 begins at step 302, where the computing device 102 accesses a recruitment profile of a player of the video game, where the recruitment profile is based at least in part on interactions of the player with the video game. At step 304, the computing device 102 accesses a plurality of available job positions. At step 306, the computing device 102, generates, for each available job position of the plurality of available job positions, based on (i) the recruitment profile, and (ii) respective information associated with the available job position: a respective predicted interest level the player would have in the available job position.

At step 308, the computing device 102 filters the plurality of available job positions to exclude available job positions with respective predicted interest levels that do not satisfy a threshold value. At step 310, the computing device 102 causes content associated with at least one available job position of the plurality of available job positions to be presented to the player via a user interface that is accessible to the player.

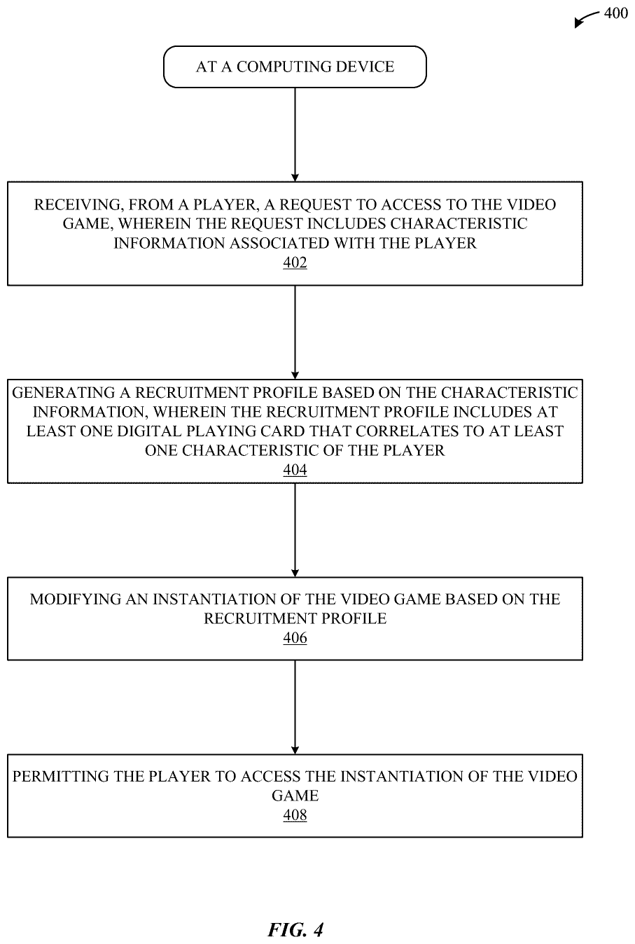

FIG. 4 illustrates a method 400 for managing recruitment profiles for players of a video game, according to some embodiments. As shown in FIG. 4, the method 400 begins at step 402, where the computing device 102 receives, from a player, a request to access to the video game, where the request includes characteristic information associated with the player. At step 404, the computing device 102 generates a recruitment profile based on the characteristic information, where the recruitment profile includes at least one digital playing card that correlates to at least one characteristic of the player. At step 406, the computing device 102 modifies an instantiation of the video game based on the recruitment profile. At step 408, the computing device 102 permits the player to access the instantiation of the video game.

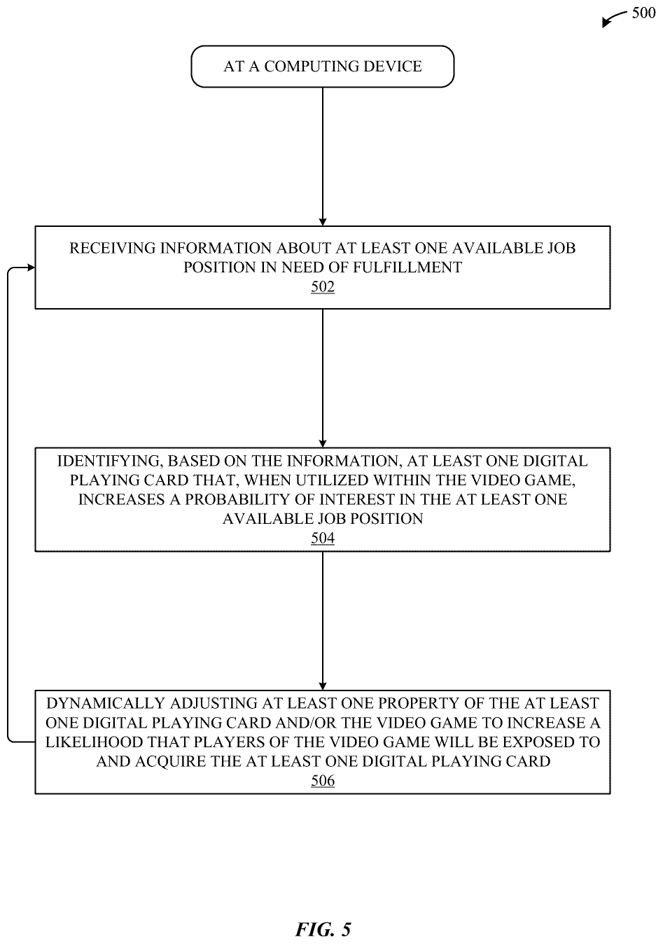

FIG. 5 illustrates a method 500 for modifying a video game based on job position recruitment goals, according to some embodiments. As shown in FIG. 5, the method 500 begins at step 502, where the computing device 102 receives information about at least one available job position in need of fulfillment. At step 504, the computing device 102 identifies, based on the information, at least one digital playing card that, when utilized within the video game, increases a probability of interest in the at least one available job position. At step 506, the computing device 102 dynamically adjusts at least one property of the at least one digital playing card and/or the video game to increase a likelihood that players of the video game will be exposed to and acquire the at least one digital playing card.

It is noted that any aspect of the video game can be generated, modified, etc., based on the at least one available job position (or any other aspect) without departing from the scope of this disclosure. For example, the computing device 102 can receive information about at least one available job position in need of fulfillment, and dynamically generate (e.g., using one or more of the machine learning models discussed herein) at least one digital playing card that corresponds to the at least one available job position. For example, if an available job position constitutes a Petroleum, Oil, and Lubricants (POL) position, then the at least one digital playing card can involve acquisition requirements related to the position, possess characteristics related to the position, and so on. The computing device 102 can also dynamically generate (e.g., using one or more of the machine learning models discussed herein) at least one mission that is based on—i.e., impacted by, involves usage of, is configured to benefit from, etc.—the at least one digital playing card. For example, the at least one mission can be configured such that it benefits from/requires the utilization of the at least one digital playing card.

Additionally, the computing device 102 can dynamically generate, modify, etc., (e.g., using one or more of the machine learning models discussed herein) at least one operational mechanic of the video game based on the at least one available job position. For example, when the at least one available job position constitutes the POL position discussed herein, the video game can be modified to award the player based on appropriate management of fuel through interactions with a simulated military base, mission, and so on. It is noted that the foregoing examples are not meant to be limiting, and that any aspect of the video game can be modified, dynamically generated, etc., at any level of granularity, based on the at least one available job position (or any other aspect), without departing from the scope of this disclosure.

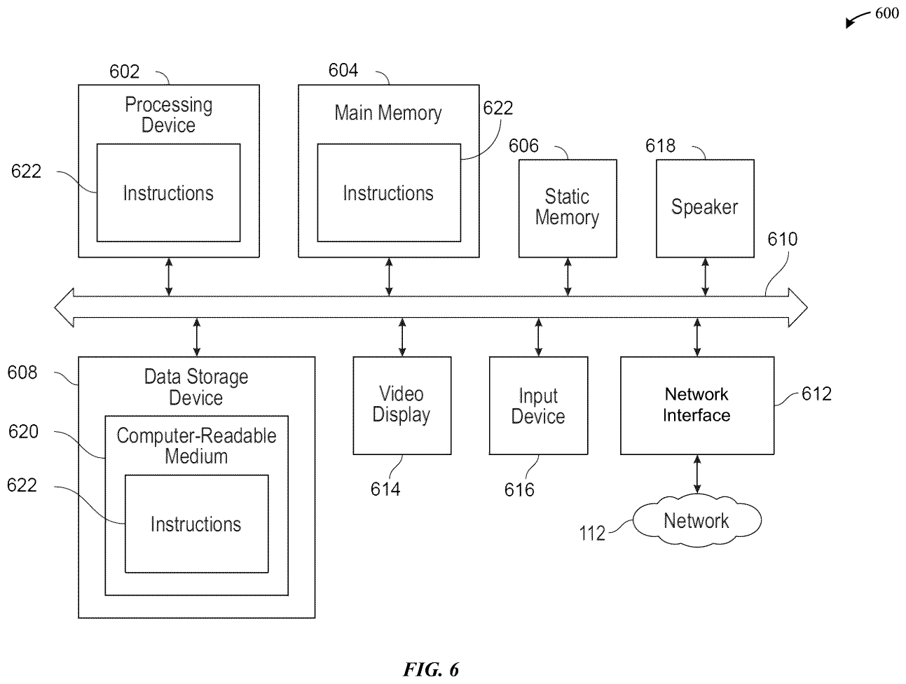

FIG. 6 illustrates an example computer system 600, which can perform any one or more of the methods described herein. In one example, computer system 600 may correspond to the computing device 102 or the one or more servers 128 of the cloud-based computing system 116 of FIG. 1. The computer system 600 may be capable of executing the application 107 (e.g., the video game) of FIG. 1. The computer system 600 may be connected (e.g., networked) to other computer systems in a LAN, an intranet, an extranet, or the Internet. The computer system 600 may operate in the capacity of a server in a client-server network environment. The computer system 600 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 600 includes a processing device 602, a main memory 604 (e.g., read-only memory (ROM), solid state drive (SSD), flash memory, dynamic random-access memory (DRAM) such as synchronous DRAM (SDRAM)), a static memory 606 (e.g., solid state drive (SSD), flash memory, static random-access memory (SRAM)), and a data storage device 608, which communicate with each other via a bus 610.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions for performing any of the operations and steps discussed herein.

The computer system 600 may further include a network interface device 612. The computer system 600 also may include a video display 614 (e.g., a liquid crystal display (LCD) or a cathode ray tube (CRT)), one or more input devices 616 (e.g., a keyboard and/or a mouse), and one or more speakers 618 (e.g., a speaker). In one illustrative example, the video display 614 and the input device(s) 616 may be combined into a single component or device (e.g., an LCD touch screen).

The data storage device 608 may include a computer-readable medium 620 on which the instructions 622 (e.g., implementing the application 107, and/or any component depicted in the FIGURES and described herein) embodying any one or more of the methodologies or functions described herein are stored. The instructions 622 may also reside, completely or at least partially, within the main memory 604 and/or within the processing device 602 during execution thereof by the computer system 600. As such, the main memory 604 and the processing device 602 also constitute computer-readable media. The instructions 622 may further be transmitted or received over a network via the network interface device 612.

While the computer-readable medium 620 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

One embodiment sets forth a method for promoting available job positions to players of a video game. According to some embodiments, the method can be implemented by a computing device, and includes the steps of (1) accessing a recruitment profile of a player of the video game, where the recruitment profile is based at least in part on interactions of the player with the video game, (2) accessing a plurality of available job positions, (3) for each available job position of the plurality of available job positions: generating, based on (i) the recruitment profile, and (ii) respective information associated with the available job position, a respective predicted interest level the player would have in the available job position, (4) filtering the plurality of available job positions to exclude available job positions with respective predicted interest levels that do not satisfy a threshold value, and (5) causing content associated with at least one available job position of the plurality of available job positions to be presented to the player via a user interface that is accessible to the player.

According to some embodiments, the recruitment profile is further based on characteristic information associated with the player.

According to some embodiments, the characteristic information is obtained by way of: (1) at least one first prompt presented to the player when engaging with a recruitment center affiliated with the video game, (2) at least one second prompt presented to the player when interacting with the video game, (3) publicly-available information about the player, or (4) some combination thereof.

According to some embodiments, the interactions comprise digital playing card collection and/or usage metrics associated with the player, wherein each digital playing card corresponds to a respective job position.

According to some embodiments, generating the respective predicted interest level for a given available job position comprises: (1) providing the recruitment profile to a first machine learning model to generate a first output; (2) providing the respective information associated with the available job position to a second machine learning model to generate a second output; and (3) generating the respective predicted interest level through analysis of the first and second outputs.

According to some embodiments, one or more of the first and second machine learning models are trained based on: (i) recruitment profiles of other players, and (ii) respective information associated with previously-available job positions that have since been filled by the other players.

According to some embodiments, the content comprises: (1) a job position title associated with the at least one available job position, (2) a geographical location of the at least one available job position, (3) compensation information associated with the at least one available job position, (4) relocation package information associated with the at least one available job position, (5) contact information of at least one entity and/or person with whom to interface, or (6) some combination thereof.

Another embodiment sets forth a method for managing recruitment profiles for players of a video game. According to some embodiments, the method can be implemented by a computing device, and includes the steps of (1) receiving, from a player, a request to access to the video game, where the request includes characteristic information associated with the player, (2) generating a recruitment profile based on the characteristic information, where the recruitment profile includes at least one digital playing card that correlates to at least one characteristic of the player, (3) modifying an instantiation of the video game based on the recruitment profile, and (4) permitting the player to access the instantiation of the video game.

According to some embodiments, generating the recruitment profile comprises: (1) providing the characteristic information to at least one machine learning model to produce an output; (2) matching the output to the at least one digital playing card; and (3) including the at least one digital playing card in the recruitment profile.

According to some embodiments, the characteristic information is obtained by way of: (1) at least one first prompt presented to the player when engaging with a recruitment center affiliated with the video game, (2) at least one second prompt presented to the player in conjunction with receiving the request to access the video game, (3) publicly-available information about the player, or (4) some combination thereof.

According to some embodiments, the method further comprises: (1) monitoring interactions of the player with the instantiation of the video game; (2) modifying the recruitment profile, based on the interactions, to produce an updated recruitment profile; and (3) modifying the instantiation of the video game based on the updated recruitment profile.

According to some embodiments, the interactions comprise digital playing card collection and/or usage metrics associated with the player, and each digital playing card corresponds to a respective job position.

According to some embodiments, the method further comprises: (1) receiving a second request to obtain a digital playing card not included in the recruitment profile; (2) identifying, based on historical information associated with acquisitions of digital playing cards by the player and/or other players, a task type that is most likely to be completed to obtain the digital playing card; (3) generating, based on the digital playing card and the task type, a task for the player to complete; and (4) providing the task to the player.

According to some embodiments, the method further comprises: (1) monitoring an execution of the task by the player; and (2) in response to determining that the player completes the task: associating the digital playing card with the recruitment profile.

Yet another embodiment sets forth a method for modifying a video game based on job position recruitment goals. According to some embodiments, the method can be implemented by a computing device, and includes the steps of (1) receiving information about at least one available job position in need of fulfillment, (2) identifying, based on the information, at least one digital playing card that, when utilized within the video game, increases a probability of interest in the at least one available job position, and (3) dynamically adjusting at least one property of the at least one digital playing card and/or the video game to increase a likelihood that players of the video game will be exposed to and acquire the at least one digital playing card.

According to some embodiments, the method further comprises dynamically adjusting at least one property of at least one available mission within the video game to increase a likelihood that players of the video game will be exposed to and pursue the at least one available mission, wherein utilization of the at least one digital playing card, when pursuing the at least one available mission, increases a likelihood of achieving the at least one available mission.

According to some embodiments, the method further comprises dynamically adjusting at least one property of at least one building structure goal within the video game to increase a likelihood that players of the video game will be exposed to and pursue the at least one building structure goal, wherein utilization of the at least one digital playing card when pursuing the at least one building structure goal increases a likelihood of achieving the at least one building structure goal.

According to some embodiments, the method further comprises: (1) identifying at least one player of the video game having a respective recruitment profile indicative of an interest in the at least one available job position; and (2) causing information about the at least one digital playing card to be presented to the at least one player.

According to some embodiments, the method further comprises: (1) identifying at least one player of the video game having a respective recruitment profile indicative of no exposure to content within the video game related to the at least one available job position; and (2) causing information about the at least one digital playing card to be presented to the at least one player.

According to some embodiments, the information is received from a government or business entity seeking to fill the at least one available job position.

The various aspects, embodiments, implementations or features of the described embodiments can be used separately or in any combination. The embodiments disclosed herein are modular in nature and can be used in conjunction with or coupled to other embodiments, including both statically-based and dynamically-based equipment. In addition, the embodiments disclosed herein can employ selected equipment such that they can identify individual users and auto-calibrate threshold multiple-of-body-weight targets, as well as other individualized parameters, for individual users.

What is claimed is:

1. A method for promoting available job positions to players of a video game, the method comprising, by a computing device:
accessing a recruitment profile of a player of the video game, wherein the recruitment profile is based at least in part on interactions of the player with the video game;
accessing a plurality of available job positions;
for each available job position of the plurality of available job positions:
generating, based on (i) the recruitment profile, and (ii) respective information associated with the available job position, a respective predicted interest level the player would have in the available job position;
filtering the plurality of available job positions to exclude available job positions with respective predicted interest levels that do not satisfy a threshold value; and
causing content associated with at least one available job position of the plurality of available job positions to be presented to the player via a user interface that is accessible to the player.

2. The method of claim 1, wherein the recruitment profile is further based on characteristic information associated with the player.

3. The method of claim 2, wherein the characteristic information is obtained by way of:
at least one first prompt presented to the player when engaging with a recruitment center affiliated with the video game,
at least one second prompt presented to the player when interacting with the video game, publicly-available information about the player, or
some combination thereof.

4. The method of claim 1, wherein the interactions comprise:
digital playing card collection and/or usage metrics associated with the player, wherein each digital playing card corresponds to a respective job position.

5. The method of claim 1, wherein generating the respective predicted interest level for a given available job position comprises:
providing the recruitment profile to a first machine learning model to generate a first output;
providing the respective information associated with the available job position to a second machine learning model to generate a second output; and
generating the respective predicted interest level through analysis of the first and second outputs.

6. The method of claim 5, wherein one or more of the first and second machine learning models are trained based on:
(i) recruitment profiles of other players, and
(ii) respective information associated with previously-available job positions that have since been filled by the other players.

7. The method of claim 1, wherein the content comprises:
a job position title associated with the at least one available job position,
a geographical location of the at least one available job position,
compensation information associated with the at least one available job position,
relocation package information associated with the at least one available job position,
contact information of at least one entity and/or person with whom to interface, or some combination thereof.

8. A method for managing recruitment profiles for players of a video game, the method comprising, by a computing device:
receiving, from a player, a request to access to the video game, wherein the request includes characteristic information associated with the player;
generating a recruitment profile based on the characteristic information, wherein the recruitment profile includes at least one digital playing card that correlates to at least one characteristic of the player;
modifying an instantiation of the video game based on the recruitment profile; and
permitting the player to access the instantiation of the video game.

9. The method of claim 8, wherein generating the recruitment profile comprises:
providing the characteristic information to at least one machine learning model to produce an output;
matching the output to the at least one digital playing card; and
including the at least one digital playing card in the recruitment profile.

10. The method of claim 8, wherein the characteristic information is obtained by way of:
at least one first prompt presented to the player when engaging with a recruitment center affiliated with the video game,
at least one second prompt presented to the player in conjunction with receiving the request to access the video game,
publicly-available information about the player, or
some combination thereof.

11. The method of claim 8, further comprising:
monitoring interactions of the player with the instantiation of the video game;
modifying the recruitment profile, based on the interactions, to produce an updated recruitment profile; and
modifying the instantiation of the video game based on the updated recruitment profile.

12. The method of claim 11, wherein:
the interactions comprise digital playing card collection and/or usage metrics associated with the player, and
each digital playing card corresponds to a respective job position.

13. The method of claim 11, further comprising:
receiving a second request to obtain a digital playing card not included in the recruitment profile;
identifying, based on historical information associated with acquisitions of digital playing cards by the player and/or other players, a task type that is most likely to be completed to obtain the digital playing card;
generating, based on the digital playing card and the task type, a task for the player to complete; and
providing the task to the player.

14. The method of claim 13, further comprising:
monitoring an execution of the task by the player; and
in response to determining that the player completes the task:
associating the digital playing card with the recruitment profile.

15. A method for modifying a video game based on job position recruitment goals, the method comprising, by a computing device:
receiving information about at least one available job position in need of fulfillment;
identifying, based on the information, at least one digital playing card that, when utilized within the video game, increases a probability of interest in the at least one available job position; and
dynamically adjusting at least one property of the at least one digital playing card and/or the video game to increase a likelihood that players of the video game will be exposed to and acquire the at least one digital playing card.

16. The method of claim 15, further comprising:
dynamically adjusting at least one property of at least one available mission within the video game to increase a likelihood that players of the video game will be exposed to and pursue the at least one available mission, wherein utilization of the at least one digital playing card, when pursuing the at least one available mission, increases a likelihood of achieving the at least one available mission.

17. The method of claim 15, further comprising:
dynamically adjusting at least one property of at least one building structure goal within the video game to increase a likelihood that players of the video game will be exposed to and pursue the at least one building structure goal, wherein utilization of the at least one digital playing card when pursuing the at least one building structure goal increases a likelihood of achieving the at least one building structure goal.

18. The method of claim 15, further comprising:
identifying at least one player of the video game having a respective recruitment profile indicative of an interest in the at least one available job position; and
causing information about the at least one digital playing card to be presented to the at least one player.

19. The method of claim 15, further comprising:
identifying at least one player of the video game having a respective recruitment profile indicative of no exposure to content within the video game related to the at least one available job position; and
causing information about the at least one digital playing card to be presented to the at least one player.

20. The method of claim 15, wherein the information is received from a government or business entity seeking to fill the at least one available job position.
